(19) United States
(12) Patent Application Publication
(10) Pub. No.: US 2004/0110550 A1
(43) Pub. Date: Jun. 10, 2004

(54) Closure for a cleanout opening of a harvesting apparatus

(76) Inventors: Glenn E. Pope, Viola, IL (US); Mark J. Reimer, Davenport, IA (US)

Correspondence Address: THE LAW OFFICE OF RANDALL T. ERICKSON, P.C., 425 W. WESLEY ST. SUITE 1, WHEATON, IL, 60187, US

(21) Appl. No.: 10/309,976

(22) Filed: Dec. 4, 2002

(51) Int. Cl. A01F 12/60

(52) U.S. Cl. 460/119

(57) ABSTRACT

A plug for a drain and grain-emptying opening for a grain compartment on a harvesting apparatus prevents clogging of the opening. The grain compartment has an auger casting for supporting a vertical unloader auger. The auger casting has openings therethrough that serve as a bottom drain for the grain compartment. The drain system includes a plug having plug bodies sized and shaped to be inserted into the openings to effectively close a bottom of the grain compartment. The openings comprise crescent shapes in horizontal cross-section, and the plug bodies comprise corresponding crescent shapes in horizontal cross-section. The plug bodies can have lengths substantially equal to depths of the openings. The plug of the invention is made from a soft plastic, which molds to the bottom surface of the casting and eliminates the need for a sealable casting cover.

### TECHNICAL FIELD OF THE INVENTION

The invention relates to harvesting apparatus, such as combines. Particularly, the invention relates to a cleanout arrangement for an auger casting in a grain compartment of a harvesting apparatus.

### BACKGROUND OF THE INVENTION

Horticultural crops may be classified as edible crops, inedible crops, genetically modified organisms (GMO's), non-GMO, organic, pesticide-free, or in accordance with other crop attributes. Inedible crops may include crops such as fiber, cotton or rubber, for example. Genetically modified crops may include vegetables that are genetically manipulated to hold their shelf life longer than traditionally cultivated vegetables. Organic crops are harvested from plants that are grown without exposure to certain pesticides, herbicides or other chemicals.

Crops may be grown to specific crop attributes or specifications. Crop attributes may be based on the genetic composition of a crop, the growing practices for a crop, or both. For example, a certain variety of corn may be grown that has greater oil content than other varieties because of genetic or environmental factors. Similarly, a certain variety of soybeans may be grown that has a different protein content or other crop attribute that is desirable. A processor, a pharmaceutical company, a manufacturer or another concern may desire to purchase agricultural products with specific crop attributes from a grower or another supplier. The grower or supplier may wish to charge a premium for crops with specific crop attributes compared to a commodity-type crop. The purchaser of the agricultural product may desire sufficient assurance that the agricultural product that is being purchased actually possesses the crop attributes that are sought.

Thus, a need exists to accurately identify crops with specific crop attributes throughout the growing and distribution of crops with specific crop attributes and any products derived therefrom. Further, a purchaser of an agricultural product or a crop may desire or demand the ability to trace the identity of the crop with specific crop attributes to verify the presence of the crop attributes, or the absence of undesired attributes, as a condition for a commercial transaction.

Thus, there is a need to segregate crops during harvesting such that no mixing of crops or crop residue with different attributes occurs. In order to ensure segregation it is preferred that harvesting apparatus, such as combines, be thoroughly cleaned each time before harvesting a crop with a different crop identity or different attributes.

In a combine, the grain compartment is open on the top to the environment. Rainwater that enters through the top of the grain compartment will seep down and collect in the lower portions of the grain compartment, especially on the left-hand side (from a driver's viewpoint) of the grain compartment under the vertical unloader auger. Under the unloader auger there is an auger casting that supports the unloader auger. The auger casting has deep drain openings or voids that are used for grain cleanout. These voids are closed by closure plates fastened onto a bottom surface of the casting. However, these voids tend to fill with water and crop material throughout their depth down to the closure plates. After the grain or other crop material sets up in the water within the voids of the casting for a period of time, the grain or other crop material will begin to rot and adhere to itself and to the casting, clogging the voids.

For cleaning the grain tank of the combine, grain and other crop material must be removed through these casting voids, once the closure plates are removed. However, because the grain or other crop material is clogging the voids, cleaning of the grain compartment is delayed until the voids can be cleared. Thus, cleaning the grain compartment is made more time consuming and difficult and necessitates the use of a stick or screwdriver to penetrate the grain or other crop material clogging the voids to effectively dig out the voids.

The present inventors have recognized that it would be advantageous if harvesting apparatus could be more quickly and easily cleaned after harvesting a crop. The present inventors have recognized that it would be advantageous if the auger casting drain openings could be more easily cleaned or otherwise kept free of clogging by crops or crop residue.

### SUMMARY OF THE INVENTION

The invention provides a closure for a cleanout system for a grain compartment on a harvesting apparatus, the grain compartment having at least one cleanout opening therethrough that serves as a bottom drain and/or grain-emptying location. The closure includes at least one plug having a plug body sized and shaped to be inserted into the opening to effectively close the bottom drain and grain-emptying location of the grain compartment for normal operation of the harvesting apparatus.

The plug can comprise a flange, the flange abutting a bottom surface of the grain compartment when the plug body is fully inserted into the opening. The grain compartment can comprise a plurality of threaded holes, and the flange can comprise a plurality of plain holes in registry with the threaded holes. A plurality of fasteners can be inserted through the plain holes and engaged into the threaded holes for fastening the plug to the grain compartment.

According to a further development of the exemplary embodiment of the invention, a harvesting apparatus has a grain compartment and an unloader auger extending into the grain compartment. An auger casting fixed to a bottom of the grain compartment supports the auger. The auger casting has at least one opening therethrough that serves as a bottom drain of the grain compartment. A plug includes a plug body sized and shaped to be inserted into the opening to effectively close a bottom of the auger casting and the grain compartment. The plug body can have a length substantially equal to a depth of the opening.

The at least one cleanout opening preferably comprises four openings arranged in two pairs, wherein each pair comprises two crescent-shaped openings in substantial parallel configuration. Two separate plugs can be used to close to the pairs of openings. Each plug comprises two crescent-shaped plug bodies in substantial parallel configuration, said plug bodies arranged to fit into said two crescent-shaped openings. Preferably, the plug bodies have a length at least as great as a depth of the openings. The handle member bridges between the two crescent-shaped plug bodies.

The plug can comprise a flange, the flange abutting a bottom surface of the auger casting when the plug body is fully inserted into the opening. The auger casting can comprise a plurality of threaded holes, and the flange can comprise a plurality of plain holes in registry with the threaded holes. A plurality of fasteners can be inserted through the plain holes and engaged into the threaded holes for fastening the plug to the auger casting.

The invention provides a plug that fills the drain openings or voids in the auger casting which act as a water drain and/or an emptying location for grain and other crop material. The plug prevents material from bridging into or building up inside the voids in the casting. The plug comprises a shape which copies the inside shape of the casting voids. The plug of the preferred embodiment of the invention is compatible with the present geometry of the auger casting of many commercially available JOHN DEERE combines.

By use of the plug, the combine cleanup time is reduced and the task is simplified. The plug of the invention can be composed of a soft plastic, which molds to the bottom surface of the casting and eliminates the need for a sealable casting cover.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is a schematical side view of a harvesting apparatus that incorporates the present invention;

FIG. 2 is a schematical plan view of the harvesting apparatus of FIG. 1;

FIG. 3 is an enlarged, fragmentary perspective view of a grain compartment area of the harvesting apparatus of FIG. 1;

FIG. 4 is an enlarged, fragmentary bottom perspective view of the grain compartment area shown in FIG. 3;

FIG. 5 is an enlarged perspective view of an auger casting with casting plugs being inserted therein;

FIG. 6 is a perspective view of the auger casting of FIG. 5 with the casting plugs fully inserted;

FIG. 7 is a rear perspective view of one casting plug;

FIG. 8 is a front perspective view of the casting plug of FIG. 7;

FIG. 9 is a front perspective view of another casting plug; and

FIG. 10 is a rear perspective view of the casting plug of FIG. 9.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

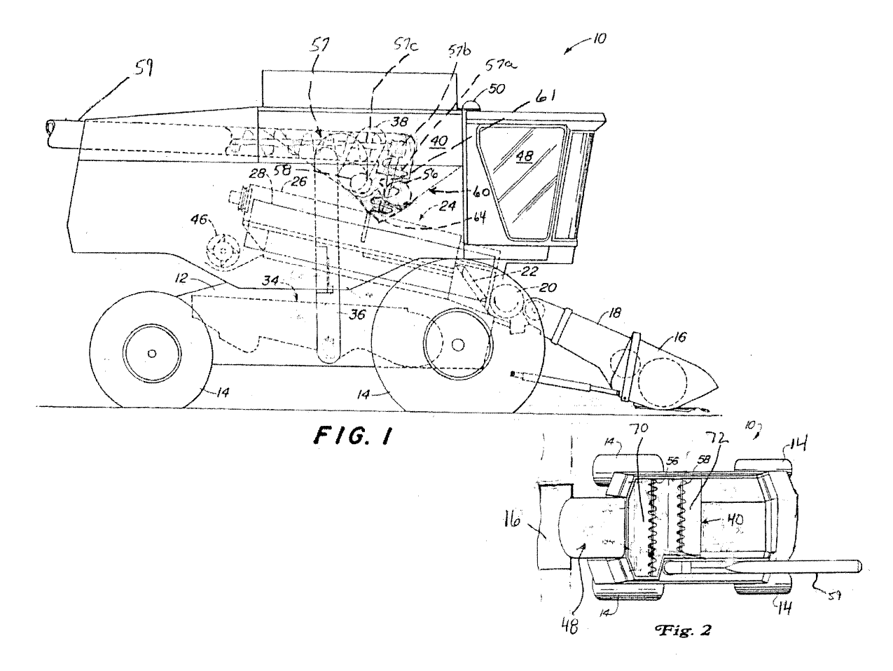

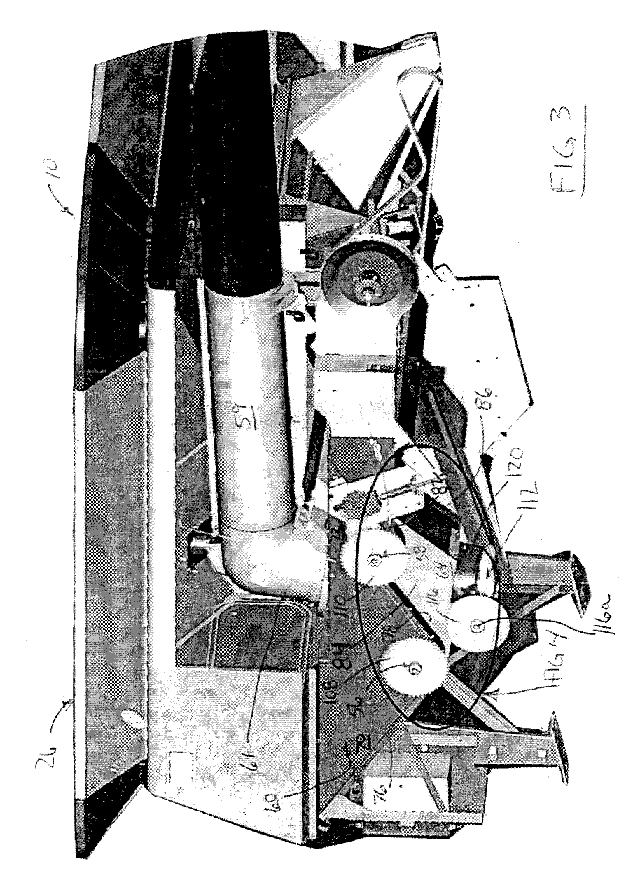

FIGS. 1 and 2 illustrate a harvesting apparatus, such as an agricultural combine 10. Such combines are of a type described for example in U.S. Pat. No. 6,285,198, herein incorporated by reference, and are also of the type commercially available as a JOHN DEERE 9650 STS or 9750 STS combine. Although the invention is being described as being incorporated into a rotary combine, it may also be used on other combines, such as conventional straw walker machines.

FIG. 1 shows an agricultural combine 10, also known as a combine thresher. The combine 10 comprises a supporting structure 12 having ground engaging means 14 extending from the supporting structure. A harvesting platform 16 is used for harvesting a crop and directing it to a feederhouse 18. The harvested crop is directed by the feederhouse 18 to a beater 20. The beater directs the crop upwardly through an inlet transition section 22 to the axial crop processing unit 24. The axial crop processing unit is located between, and supported by the sidesheets of the combine.

The axial crop processing unit 24 comprises an axial rotor housing 26 and an axial rotor 28 located in the housing. The harvested crop enters the housing through the inlet transition section 22. The rotor is provided with an infeed portion, a threshing portion and a separating portion. The rotor housing has a corresponding infeed section, a threshing section and a separating section.

Both crop processing portions, the threshing portion and the separating portion, are provided with crop engaging assemblies. The threshing section of the rotor housing is provided with a concave and the separating section is provided with a grate. Grain and chaff released from the crop mat falls through the concave and the grate. The concave and grate prevent the passage of crop material larger than grain or chaff from entering the cleaning system 34.

As illustrated in FIG. 1, grain and chaff falling through the concave and grate is directed to cleaning system 34 which removes the chaff from the grain. The clean grain is then directed by a clean grain elevator 36 to a fountain auger 38. The fountain auger 38 directs the grain into a grain tank or grain compartment 40. The clean grain elevator 36 and the fountain auger 38 comprise a means for moving the clean grain from the grain floor of the combine to a storage bin formed by the grain tank 40. The grain is removed from the grain tank 40 by unloading auger 57. As the straw reaches the end of the crop processing unit it is expelled through an outlet to a beater 46. The beater 46 propels the straw out the rear of the combine. The operation of the combine is controlled from the operator's cab 48.

When the clean grain compartment 40 is to be unloaded, transverse unloading augers 56 and 58 direct the grain to the side of the compartment where it comes into contact with the unloading auger 57 which directs the clean grain through a vertical unloading tube 61 and a horizontal unloading tube 59. The auger 57 includes a vertical section 57a, at least partially within the tube 61, a right angle gear 57b, and a horizontal section 57c within the tube 59. During an unloading operation, tube 59 would normally be extended outwardly from the side of the combine so that clean grain can be more readily directed into a wagon or truck.

The grain compartment 40 includes a trough 60, which includes a major trough region 70 and a minor trough region 72 that house the horizontal augers 56, 58, respectively. The trough 60 is open to a charge housing or sump 64. The vertical auger 57 extends through the vertical tube 61 and into the sump 64. The grain which is fed through the trough horizontally by the horizontal augers 56, 58 is delivered into the sump 64 and is removed by the vertical auger section 57a through the tube 61, and by the horizontal auger section 57c through the tube 59.

As illustrated in FIG. 3, the major trough region 70 includes a forward inclined wall 76 and a rearward inclined wall 78. The minor trough region 72 includes a rearward inclined wall 82 that curves into the rearward inclined wall 78 of the major trough region 70. The sump 64 includes parallel sidewalls 84 that extend substantially parallel and vertical and are fastened substantially continuously to the inclined walls 78, 82. Only the left side sump sidewall 84 is visible in the Figures, the right side sump sidewall is substantially the same shape as the left side sidewall.

The augers 56, 58 are driven by sprockets 108, 110. The auger 57 is driven by a right angle gear drive 112 that is driven by a sprocket 116. The drive arrangement for turning the sprockets is described in more detail in U.S. Pat. No. 4,967,863, or as described in U.S. application Ser. No. ______, filed on the same day as the present application, and identified by attorney docket No. 6301P0070US, both herein incorporated by reference.

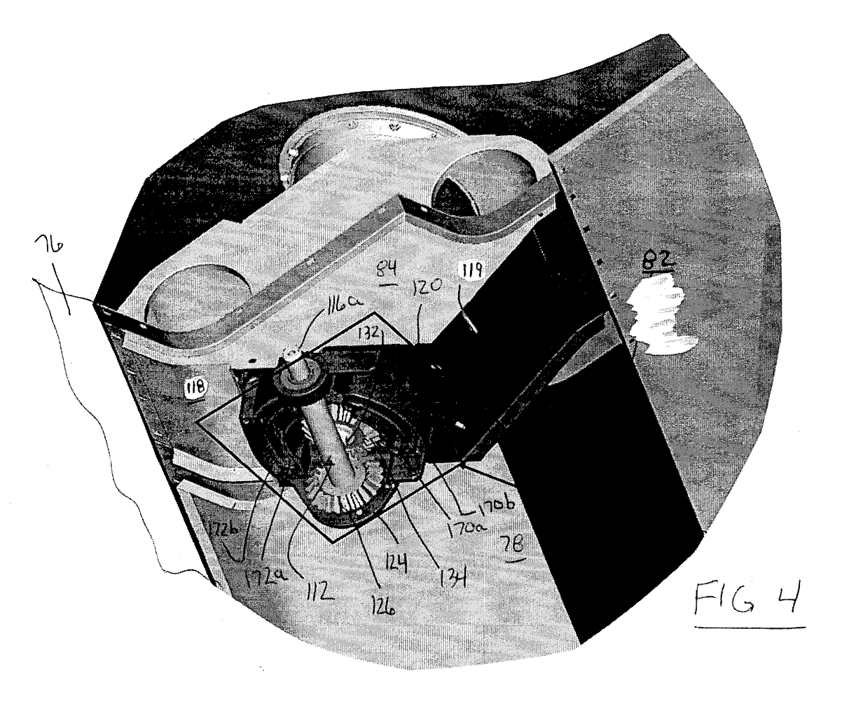

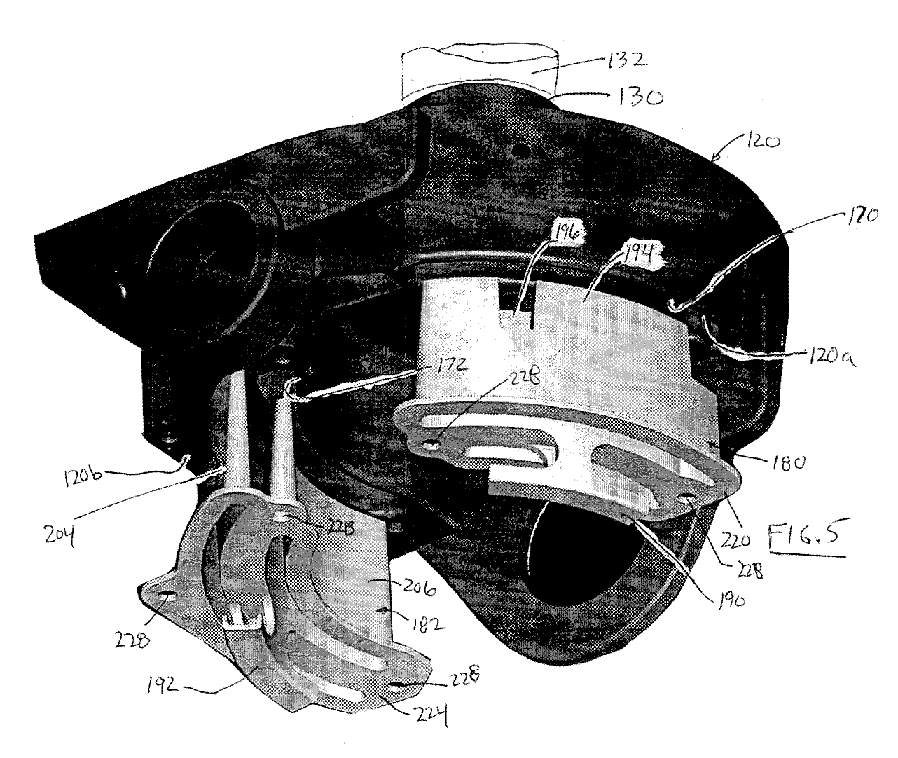

As illustrated in FIG. 4, the sump includes a front oblique wall 118, a rear oblique wall 119, and an auger casting 120. The auger casting 120 is fastened to the oblique walls 118, 119. The front oblique wall 118 is fastened to the forward inclined wall 76 and the sidewalls 84, 86. The rear oblique wall 119 is fastened to the rearward inclined wall 82 and the sump sidewalls 84. The sump sidewalls 84, the auger casting 120, and the walls 118, 119 form a substantially enclosed sump 64 except for drain openings described below. When plugs (described below) are installed into the casting 120, the sump 64 is substantially sealed against the trough region 70, 72.

The auger casting 120 includes journals 122, 124 for rotatably holding a horizontal axis gear assembly 126 for the right angle gear drive 112. The auger casting 120 also includes a journal 130 (FIG. 5) for supporting and rotationally holding a vertical axle 132 of the auger 57. A vertical axis gear 134 is fixed to the axle 132. Turning of the gear 134 turns the auger 57.

The auger casting 120 includes two pairs of drain openings 170a, 170b; 172a, 172b that allow the sump 64 to be drained of water or emptied of grain and other crop material.

As illustrated in FIG. 5, the invention provides at least one, and preferably two plugs 180, 182 each having one or more plug bodies 194, 196, 204, 206 each sized and shaped to be inserted into one opening 170a, 170b, 172a, 172b to effectively close a bottom of the auger casting 120 and thus the sump 64.

Each opening 170a, 170b, 172a, 172b comprises a crescent shape in horizontal cross-section, and the corresponding plug body the 94, 196, 204, 206 comprises a corresponding crescent shape in horizontal cross-section. Each plug 180, 182 comprises a handle member 190, 192 extending from bottoms of adjacent plug bodies 194, 196, 204, 206. Each plug body 194, 196, 204, 206 can have a length substantially equal to a depth of the respective opening 170a, 170b, 172a, 172b.

Each plug 180, 182 can comprise a flange 220, 224, the flange abutting a bottom surface 120a, 120b of the auger casting 120 when the plug bodies 180, 182 are fully inserted into the openings 170a, 170b, 172a, 172b. The auger casting 120 can comprise a plurality of threaded holes 226, and the flanges 220, 224 can comprise a plurality of plain holes 228 in registry with the threaded holes 226. A plurality of wing fasteners 230 with washers 231 (one shown) can be inserted through the plain holes 228 and engaged into the threaded holes 226 for fastening the plugs 180, 182 to the auger casting 120.

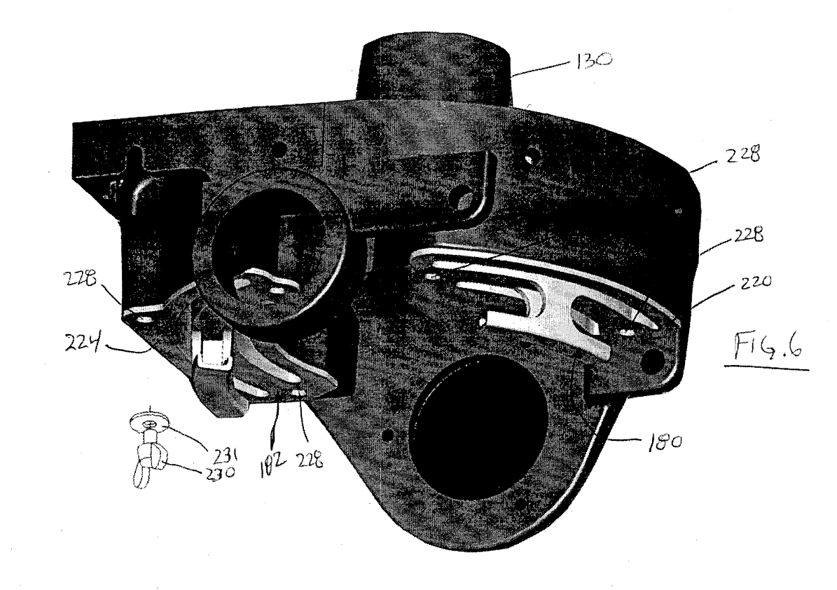

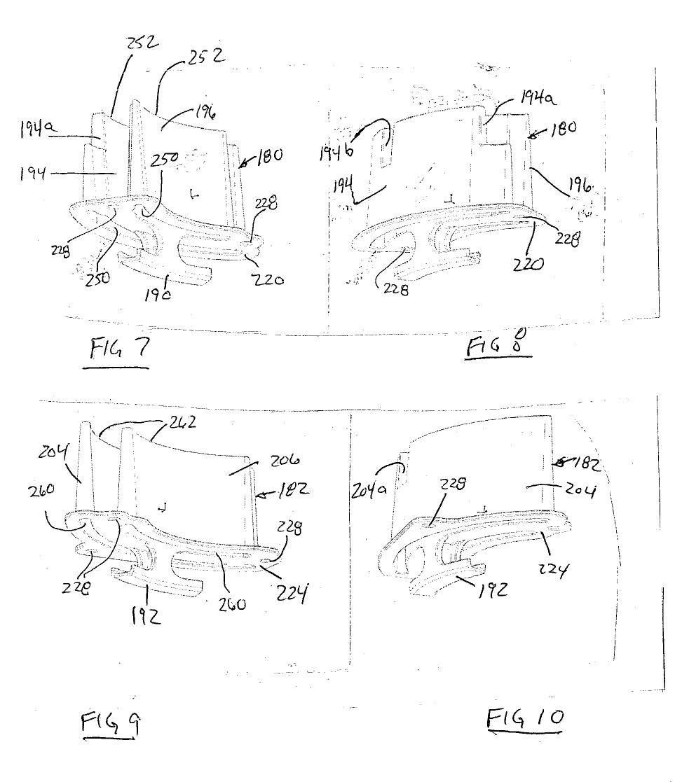

FIGS. 7 and 8 illustrate the plug 180. The rear plug body 194 includes strategically located cutouts 194a, 194b that prevent interference of the plug body 194 with the fasteners used to fasten the casting 120 to the sump wall 119 (FIG. 4).

FIGS. 9 and 10 illustrate the plug 182. The front plug body 204 includes a strategically located cutout 204a that prevent interference of the plug body 194 with the fasteners used to fasten the casting 120 to the sump wall 118 (FIG. 4).

Each plug body 194, 196, 204, 206 is substantially hollow with an open bottom end 250 and a closed top end 252. The hollow characteristic of the plug allows for a resilient compression inside the openings 170a, 170b, 172a, 172b to more closely conform the plug body 194, 196, 204, 206 to the openings 170a, 170b, 172a, 172b. Additionally, the hollow configuration allows the plugs 180, 182 to be more easily molded.

The plugs 180, 182 are preferably composed of a soft plastic, which molds to the bottom surface of the casting and eliminates the need for a sealable casting cover. Other plastic materials, or other non-plastic materials, could also be used and are encompassed by the invention.

The plugs 180, 182 prevent material from bridging into the openings 170a, 170b, 172a, 172b in the casting. The plugs 180, 182 of the invention are compatible with the present geometry of the auger casting of many commercially available JOHN DEERE combines.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

The invention claimed is:

1. In a harvesting apparatus having a grain compartment, said grain compartment having at least one opening therethrough that serves as a bottom drain, the improvement comprising:
a plug having a plug a body sized and shaped to be at least partially inserted into the opening to effectively close a bottom of said grain compartment.

2. The improvement according to claim 1, wherein said opening comprises a crescent shape in horizontal cross-section and said plug body comprises a crescent shape in horizontal cross-section.

3. The improvement according to claim 1, wherein said plug comprises a handle member connected to a bottom of said plug body.

4. The improvement according to claim 1, wherein said opening comprises two crescent-shaped openings in substantial parallel configuration, and said plug comprises two crescent-shaped plug bodies in substantial parallel configuration, said plug bodies arranged to fit into said two crescent-shaped openings.

5. The improvement according to claim 4, wherein said plug comprises a handle member, wherein said handle member bridges between said two crescent-shaped plug bodies.

6. The improvement according to claim 1, wherein said plug comprises a flange, said flange abutting a bottom surface of said grain compartment when said plug body is fully inserted into said opening.

7. The improvement according to claim 6, wherein said grain compartment comprises a plurality of a threaded holes, and said flange comprises a plurality of plain holes in registry with said threaded holes, and further comprising a plurality of fasteners, said threaded holes and said plain holes receiving said fasteners for fastening said plug to said grain compartment.

8. The improvement according to claim 1, wherein said plug body has a length substantially equal to a depth of said opening.

9. In a harvesting apparatus having a grain compartment and an unloader auger extending into the grain compartment, and an auger casting fixed to a bottom of the grain compartment to support the auger, said casting having at least one opening therethrough that serves as a bottom drain of the grain compartment, the improvement comprising:
a plug having a plug a body sized and shaped to be inserted into the opening to effectively close a bottom of said grain compartment.

10. The improvement according to claim 9, wherein said opening comprises a crescent shape in horizontal cross-section and said plug body comprises a crescent shape in horizontal cross-section.

11. The improvement according to claim 9, wherein said plug comprises a handle member connected to a bottom of said plug.

12. The improvement according to claim 9, wherein said opening comprises two crescent-shaped openings in substantial parallel configuration, and said plug comprises two crescent-shaped plug bodies in substantial parallel configuration, said plug bodies arranged to fit into said two crescent-shaped openings.

13. The improvement according to claim 12, wherein said plug comprises a handle member, wherein said handle member bridges between said two crescent-shaped plug bodies.

14. The improvement according to claim 9, wherein said plug comprises a flange, said flange abutting a bottom surface of said casting when said plug body is fully inserted into said opening.

15. The improvement according to claim 14, wherein said casting comprises a plurality of a threaded holes, and said flange comprises a plurality of the plain holes in registry with said threaded holes, and further comprising a plurality of fasteners, said threaded holes and said plain holes receiving said fasteners for fastening said plug to said casting.

16. The improvement according to claim 9, wherein said plug body has a length substantially equal to a depth of said opening.
